(19) United States
(12) Patent Application Publication
(10) Pub. No.: US 2026/0261359 A1
(43) Pub. Date: Sep. 3, 2026

(54) ENHANCED CODE BLOCK GROUP-BASED TRANSMISSION WITH DEPENDENCY BETWEEN BLOCKS FOR MULTI-FLOW TRAFFICS

(71) Applicant: Nokia Technologies Oy, Espoo (FI)

(72) Inventors: Abolfazl AMIRI, Aalborg (DK); Klaus Ingemann PEDERSEN, Aalborg (DK)

(21) Appl. No.: 18/878,894

(22) PCT Filed: Mar. 29, 2023
(86) PCT No.: PCT/EP2023/058101

§ 371 Date: Dec. 25, 2024

Related U.S. Application Data
(60) Provisional application No. 63/356,064, filed on Jun. 28, 2022.

(51) Int. Cl. H04L 1/00

(52) U.S. Cl. CPC H04L 1/0041; H04L 1/0061

(57) ABSTRACT

Systems, methods, apparatuses, and computer program products for indicating dependencies between portions of transport blocks carrying data from different radio bearers. One method may include transmitting, by a network entity, downlink control information indicating a dependency between two consecutive transport blocks to a user equipment, transmitting, by the network entity, a plurality of code blocks of the consecutive transport blocks associated with the same radio bearer including a cyclic redundancy check to the user equipment, and receiving, by the network entity, at least one acknowledgement of successful decoding of at least one of the plurality of code blocks.

### CROSS REFERENCE TO RELATED APPLICATION

This application claims priority from U.S. provisional patent application No. 63/356,064 filed on Jun. 28, 2022. The contents of this earlier filed application are hereby incorporated by reference in their entirety.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for indicating dependencies between portions of transport blocks (TBs) carrying data from different radio bearers (RBs).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (UE) (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, by a network entity, downlink control information indicating a dependency between two consecutive transport blocks to a user equipment. The method may further include transmitting, by the network entity, a plurality of code blocks of the consecutive transport blocks associated with the same radio bearer comprising a cyclic redundancy check to the user equipment. The method may further include receiving, by the network entity, at least one acknowledgement of successful decoding of at least one of the plurality of code blocks.

In accordance with certain example embodiments, an apparatus may include means for transmitting downlink control information indicating a dependency between two consecutive transport blocks to a user equipment. The apparatus may further include means for transmitting a plurality of code blocks of the consecutive transport blocks associated with the same radio bearer comprising a cyclic redundancy check to the user equipment. The apparatus may further include means for receiving at least one acknowledgement of successful decoding of at least one of the plurality of code blocks.

In accordance with various example embodiments, a non-transitory computer readable medium may be encoded with instructions that may, when executed in hardware, perform a method. The method may include transmitting downlink control information indicating a dependency between two consecutive transport blocks to a user equipment. The method may further include transmitting a plurality of code blocks of the consecutive transport blocks associated with the same radio bearer comprising a cyclic redundancy check to the user equipment. The method may further include receiving at least one acknowledgement of successful decoding of at least one of the plurality of code blocks.

In accordance with some example embodiments, a computer program product may perform a method. The method may include transmitting downlink control information indicating a dependency between two consecutive transport blocks to a user equipment. The method may further include transmitting a plurality of code blocks of the consecutive transport blocks associated with the same radio bearer comprising a cyclic redundancy check to the user equipment. The method may further include receiving at least one acknowledgement of successful decoding of at least one of the plurality of code blocks.

In accordance with certain example embodiments, an apparatus may include at least one processor and at least one memory including computer program code. The at least one memory and the computer program code may be configured to, with the at least one processor, cause the apparatus to at least transmit downlink control information indicating a dependency between two consecutive transport blocks to a user equipment. The at least one memory and the computer program code may be further configured to, with the at least one processor, cause the apparatus to at least transmit a plurality of code blocks of the consecutive transport blocks associated with the same radio bearer comprising a cyclic redundancy check to the user equipment. The at least one memory and the computer program code may be further configured to, with the at least one processor, cause the apparatus to at least receive at least one acknowledgement of successful decoding of at least one of the plurality of code blocks.

In accordance with various example embodiments, an apparatus may include circuitry configured to transmit downlink control information indicating a dependency between two consecutive transport blocks to a user equipment. The circuitry may further be configured to transmit a plurality of code blocks of the consecutive transport blocks associated with the same radio bearer comprising a cyclic redundancy check to the user equipment. The circuitry may further be configured to receive at least one acknowledgement of successful decoding of at least one of the plurality of code blocks.

In accordance with some example embodiments, a method may include receiving, by a user equipment, downlink control information from a network entity indicating a dependency between two consecutive transport blocks. The method may further include receiving, by the user equipment, a plurality of code blocks of the consecutive transport blocks associated with the same radio bearer comprising a cyclic redundancy check from the network entity. The method may further include recovering, by the user equipment, data based upon the downlink control information. The method may further include transmitting, by the user equipment, at least one successfully decoded bundle with all code blocks correctly decoded to an upper layer of the user equipment. The method may further include transmitting, by the user equipment, at least one acknowledgement of successful decoding of at least one the plurality of code blocks to the network entity.

In accordance with certain example embodiments, an apparatus may include means for receiving downlink control information from a network entity indicating a dependency between two consecutive transport blocks. The apparatus may further include means for receiving a plurality of code blocks of the consecutive transport blocks associated with the same radio bearer comprising a cyclic redundancy check from the network entity. The apparatus may further include means for recovering data based upon the downlink control information. The apparatus may further include means for transmitting at least one successfully decoded bundle with all code blocks correctly decoded to an upper layer of the user equipment. The apparatus may further include means for transmitting at least one acknowledgement of successful decoding of at least one the plurality of code blocks to the network entity.

In accordance with various example embodiments, a non-transitory computer readable medium may be encoded with instructions that may, when executed in hardware, perform a method. The method may include receiving downlink control information from a network entity indicating a dependency between two consecutive transport blocks. The method may further include receiving a plurality of code blocks of the consecutive transport blocks associated with the same radio bearer comprising a cyclic redundancy check from the network entity. The method may further include recovering data based upon the downlink control information. The method may further include transmitting at least one successfully decoded bundle with all code blocks correctly decoded to an upper layer of the user equipment. The method may further include transmitting at least one acknowledgement of successful decoding of at least one the plurality of code blocks to the network entity.

In accordance with some example embodiments, a computer program product may perform a method. The method may include receiving downlink control information from a network entity indicating a dependency between two consecutive transport blocks. The method may further include receiving a plurality of code blocks of the consecutive transport blocks associated with the same radio bearer comprising a cyclic redundancy check from the network entity. The method may further include recovering data based upon the downlink control information. The method may further include transmitting at least one successfully decoded bundle with all code blocks correctly decoded to an upper layer of the user equipment. The method may further include transmitting at least one acknowledgement of successful decoding of at least one the plurality of code blocks to the network entity.

In accordance with certain example embodiments, an apparatus may include at least one processor and at least one memory including computer program code. The at least one memory and the computer program code may be configured to, with the at least one processor, cause the apparatus to at least receive downlink control information from a network entity indicating a dependency between two consecutive transport blocks. The at least one memory and the computer program code may be further configured to, with the at least one processor, cause the apparatus to at least receive a plurality of code blocks of the consecutive transport blocks associated with the same radio bearer comprising a cyclic redundancy check from the network entity. The at least one memory and the computer program code may be further configured to, with the at least one processor, cause the apparatus to at least recover data based upon the downlink control information. The at least one memory and the computer program code may be further configured to, with the at least one processor, cause the apparatus to at least transmit at least one successfully decoded bundle with all code blocks correctly decoded to an upper layer of the user equipment. The at least one memory and the computer program code may be further configured to, with the at least one processor, cause the apparatus to at least transmit at least one acknowledgement of successful decoding of at least one the plurality of code blocks to the network entity.

In accordance with various example embodiments, an apparatus may include circuitry configured to receive downlink control information from a network entity indicating a dependency between two consecutive transport blocks. The circuitry may further be configured to receive a plurality of code blocks of the consecutive transport blocks associated with the same radio bearer comprising a cyclic redundancy check from the network entity. The circuitry may further be configured to recover data based upon the downlink control information. The circuitry may further be configured to transmit at least one successfully decoded bundle with all code blocks correctly decoded to an upper layer of the user equipment. The circuitry may further be configured to transmit at least one acknowledgement of successful decoding of at least one the plurality of code blocks to the network entity.

### BRIEF DESCRIPTION OF THE DRAWINGS

For a proper understanding of example embodiments, reference should be made to the accompanying drawings, wherein:

FIG. 1 illustrates an example of several internet protocol (IP) packets from different RBs being multiplexed into one medium access control (MAC) protocol data unit (PDU) that are then scheduled into one TB.

FIG. 2 illustrates an example of a UE running multiple services with different delay sensitivities at the same time.

FIG. 3 illustrates an example of a signaling diagram according to certain example embodiments.

FIG. 4 illustrates an example of differential phase shifting key (DPSK) coding for code block group dependency information (CBGDI) with three simultaneous RBs and the presence of radio link control (RLC) segmentation.

FIG. 5 illustrates an example of modified MAC protocol data unit (PDU) packet generation when RBs are mapped into different code block groups (CBGs) that may be forwarded independently to upper layers (if received correctly) without waiting for recovery of the remaining TBs.

FIG. 6 illustrates an example of a flow diagram of a method according to various example embodiments.

FIG. 7 illustrates an example of a flow diagram of another method according to some example embodiments.

FIG. 8 illustrates an example of various network devices according to some example embodiments.

FIG. 9 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for indicating dependencies between portions of TBs carrying data from different RBs is not intended to limit the scope of certain example embodiments, but is instead representative of selected example embodiments.

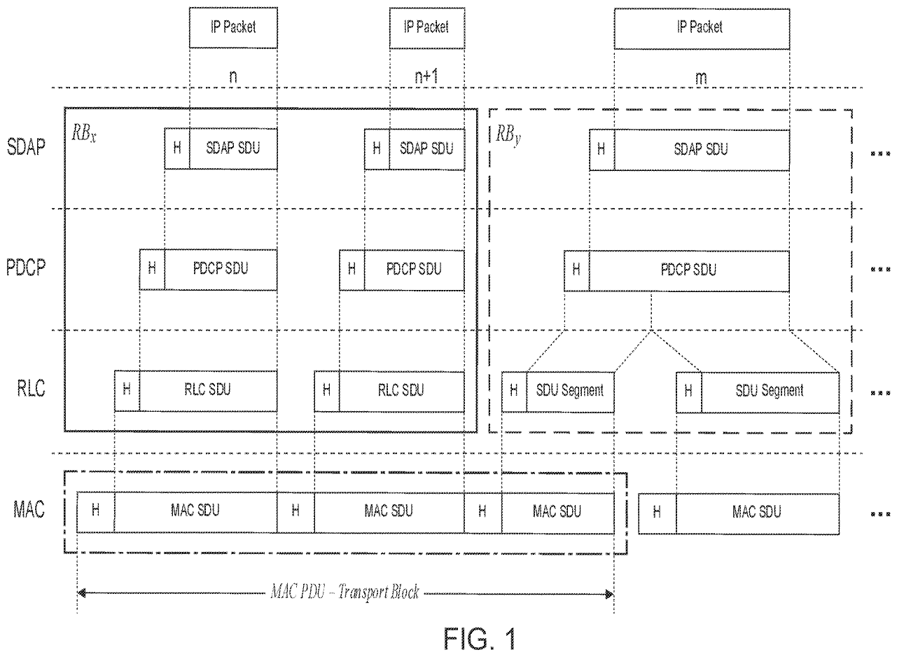

5G NR currently supports multiplexing of several RBs into one TB in order to increase the radio resource efficiency compared to multiple data transmissions from different RBs in several TBs, each with a separate grant. FIG. 1 illustrates a data flow chart of an example case where multiple IP packets are multiplexed into one TB. As shown, data from multiple RBs may fall into one TB if no further information is available at the TB defining the relationship between fragments of the data in the TB. Thus, the medium access control (MAC) layer may process all code blocks (CBs) inside the TB equally, and the reception may only be successful when all the CBs are decoded correctly (e.g., by checking their cyclic redundancy check (CRC)). However, this technique has some disadvantages when multiplexing data from several different RBs with different delay requirements (e.g., mixing extended reality (XR) with enhanced mobile broadband (eMBB)). For example, delay sensitive traffic may suffer from excessive time spent waiting for other traffic flows to be received. This may especially occur when all CBs from one RB are received correctly, but one or more CBs from other RBs have failed and require retransmission; as a result, the successfully received CBs are buffered until all of the CBs are received correctly, before being forwarded to upper layers for further processing. For the delay sensitive traffic, this extra waiting time may cause the packet delay budget (PDB) deadline (e.g., 10 ms for XR type traffic) to be exceeded, and eventually, data may be missed entirely while being buffered at the MAC layer despite being correctly decoded. The problem may become even more severe with delay critical services (e.g., fifth generation quality of service indicator (5QI) index=85 with PDB=5 ms) when multiplexed with other traffic types.

Certain embodiments may provide a solution to create an enhanced TB transmission mode, wherein independent segments of data in the TB may be forwarded to the upper layers at the receiver side without having to wait for successful reception of all data in the TB. Independent segments of data may refer to RLC PDUs that are from different RBs (potentially with different quality of service (QoS) requirements). Independent segments of data may also correspond to different RLC PDUs of the same RB (e.g., PDUs that have arrived at different times at the base station, and therefore have different times left before violating PDB of the RB).

Certain example embodiments described herein may have various benefits and/or advantages to overcome the disadvantages described above. For example, certain example embodiments may enhance downlink transmission of TBs where independent segments of the data are handled separately at the reception in order to reduce processing latency. For delay sensitive traffic (e.g., delay critical services with 5QI index=85 with PDB=5 ms and/or XR video streaming with PDB=10 ms), where at the reception and upon being correctly decoded, data can be forwarded to upper layers for further processing. Similarly, even when data is from a single RB, but some packets reach a PDB deadline, certain embodiments enable forwarding of these packets to upper layers to avoid delays caused by transmission failure of other packets in the same TB. As a result, the TB is only forwarded to upper layers if all the CBs are received and decoded correctly, resulting in a higher processing delay for the partitions of the TB (CBG bundles from one RB) that are decodable but pending for retransmissions of other bundles. In addition, a retransmission process may take several milliseconds, which is comparable to the delay budget of 5 ms in case of the delay critical services. Therefore, certain example embodiments discussed below are directed to improvements in computer-related technology by avoiding such unnecessary waiting times, thereby reducing latency and improve end user service experience.

As used throughout this disclosure, a “CB bundle” (i.e., “CBG”) may refer to a group of one or more CBs that correspond to a continuous part of a TB (e.g., consecutive). For example, a TB may include 9 CBs and CB bundles, wherein CB bundle 1 includes CB indices 1, 2, and 3, CB bundle 2 includes CB indices 4, 5, and 6, and CB bundle 3 includes the remaining CBs. Furthermore, a “CBG bundle” may refer to a set of one or more CBGs (each with several CBs) with sequential indices (e.g., CBG 1 may be in CBG bundle 1, while CBG 2 and CBG 3 may be in CBG bundle 2). Finally, a plurality of CBs may refer to a set of CBs which may or may not have sequential CB indices.

In general, CBG-based transmission may be used where the TB is composed of one or more CBGs. More specifically, a mapping between each RB to one or multiple CBGs may define dependencies between the CBGs related to the same RB. However, embodiments discussed herein are not only limited to CBG; data from different RBs may also be mapped to different partitions of the TB (composed of several CBs). The dependencies may be defined between those partitions, and this relationship between the CBGs from the same RB may enable forwarding of the dependencies to higher layers upon being correctly decoded, without extra delays for the rest of the CBGs to be fully decoded. In this way, additional waiting time may be avoided, especially for delay sensitive RB packets (e.g., XR and Ultra Reliable Low Latency Communication (URLLC)) caused by retransmission of other CBGs that may carry traffic from other RBs with other types of services (i.e., different latency targets). In addition, the CBGs (or CBs) in one TB may be independent, and dependencies may be introduced between different CBGs (or CBs) so they can be forwarded to higher layers in case of being decodable. In some various embodiments, if all CBGs (or CBs) depend upon each other, independencies may be indicated between the separate CBGs (or CBs) for the same application.

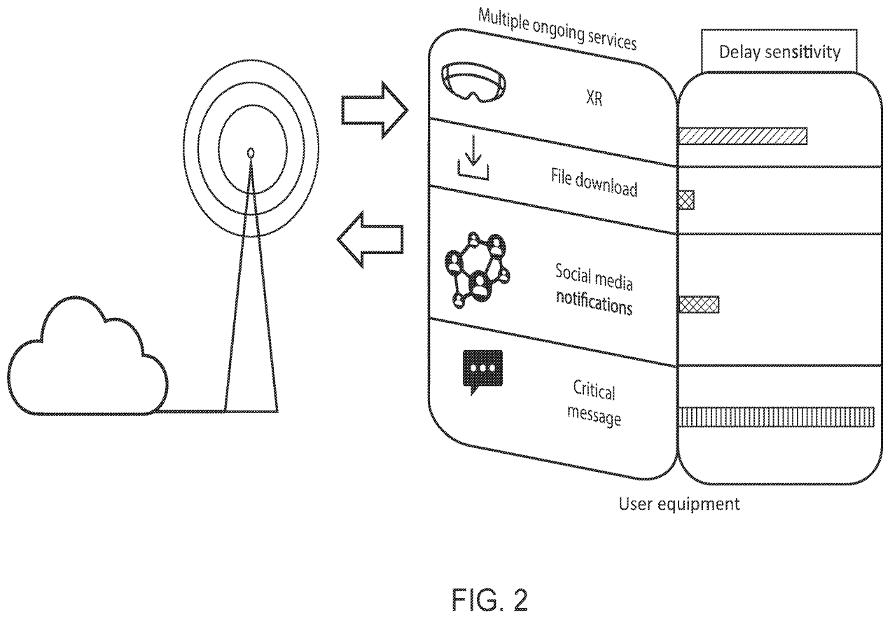

Certain embodiments described below may relate to 5G-Advanced Release 18 item on enhancements for XR, but are not necessarily limited to this 3GPP item. Certain embodiments may also relate to advanced XR use cases where the frames have more complex reliance patterns, multiplexing of user- and control-plane traffic in one TB, and multiplexing various traffic types (e.g., a critical RRC handover command and best effort enhanced mobile broadband (eMBB) data). FIG. 2 illustrates a general overview of multiple services running on a UE, with each service having a different delay sensitivity. To accommodate these needs, some embodiments discussed herein may enable faster delivery of the data from each RB independently, without waiting for decoding of other RBs transmitted in the same TB.

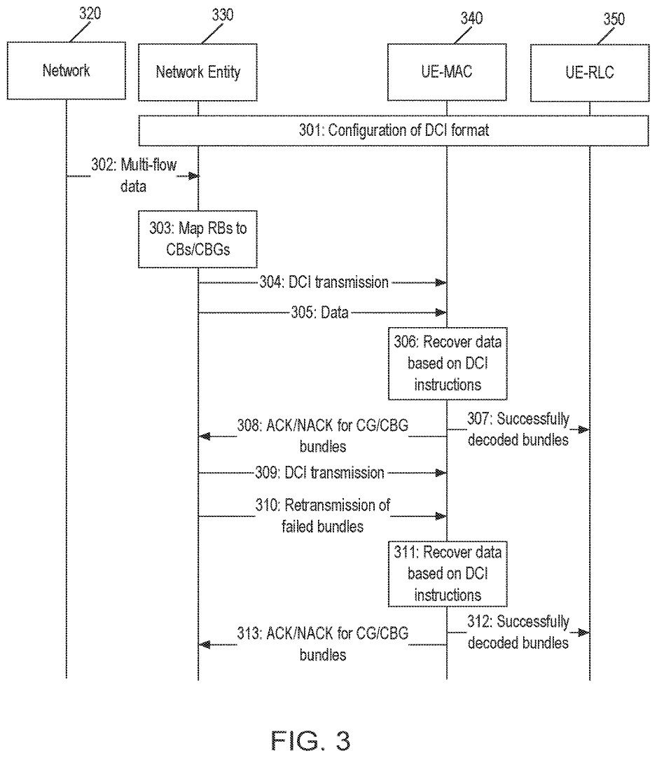

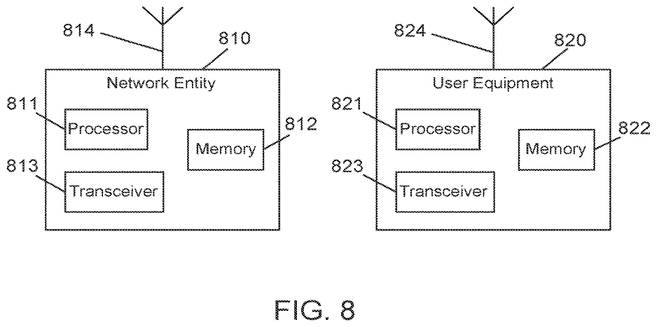

FIG. 3 illustrates an example of a signaling diagram depicting for indicating dependencies between portions of TBs carrying data from different RBs. NE 330 and UE-MAC 340 and UE-RLC 350 (components of a UE) may be similar to NE 810 and UE 820, respectively, as illustrated in FIG. 8, according to certain example embodiments.

At 301, NE 330 may configure the UE of UE-MAC 340 and UE-RLC 350 to use a particular DCI format. For example, the DCI format may include a CBG dependency information (CBGDI) field, which may define the dependencies between the CBGs (CBG bundles) that define the mapping of different RBs into each CBG bundle. CBGDI may also define dependencies of previous TBs in cases of RLC segmentation. In addition, a CBG new data indicator (CBGNDI) field may define if data from each bundle is new (first transmission) or not (retransmission).

In some example embodiments, a CBGDI field may include a vector that indicates starting bits of each of the CB/CBG bundles. For instance, vector [i,j,k] may indicate that the first bundle starts from bit 1 to i−1, the second bundle starts from bit i to j−1, the third bundle starts from bit j to k−1, and the last bundle starts from k until the end of the current TB. Additionally or alternatively, a CBGDI field may include a vector that indicates the length of the bundles, such as [i,j−i,k−j,TBS−k], where TBS shows the TB size. This option may require smaller number of bits compared to the vector above that indicates starting bits.

CBG-based modes may include a CBGDI field with a vector indicating the starting index of the first CBG in the bundle starting from the second bundle (i.e., a bundle always starts from CBG #1). For example, in a scenario with three bundles, the vector could be [x,y] with 1<x<y<C, wherein C is the maximum configured number of CBGs. Therefore, the first bundle may include CBGs 1 to x−1, the second bundle may include x to y−1 and the last bundle may include the remaining CBGs. CBG-based modes may also include a CBGDI field with a vector indicating the length of the bundles by CBG counts, vector [x−1,y−x,C−y+1] with 1<x<y<C. This configuration may require a smaller number of bits compared to the starting index of the first CBG in the bundle.

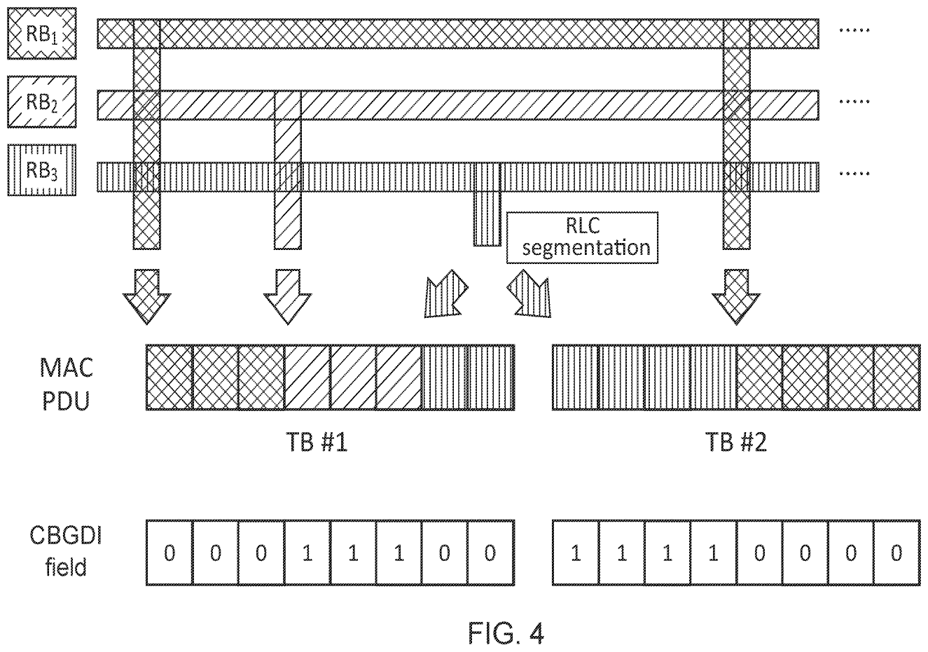

CBG-based modes may also include a CBGDI field with a vector having C bits, wherein each bit indicates whether the CBG is in a bundle with the previous bundle, similar to differential phase shift keying (DPSK). In this way, the initial phase may be set to 0 if the first CBG is unrelated to the previous TB (e.g., due to RLC segmentation), and may be set to 1 otherwise. As depicted in FIG. 4, 3 RBs may be mapped to 2 TBs, with 8 CBGs in each TB. The CBGDI field may indicate the dependency based on phase shift when the RB index is changing. For TB #2, since the RLC segmentation is present in RB #3 and some of the data was sent in the previous TB, the initial phase starts at 1.

In addition to a CBGDI field, the DCI format may include a CBGNDI field, with options similar to the CBGDI field. For example, a CBGNDI field may indicate the starting bit that contains new data (or retransmission data). Moreover, a CBGNDI field may use only X bits (i.e., number of RBs in current TB), wherein bit 1 indicates new data, and bit 0 indicates retransmission data for each of the RBs. The CBGDI field may indicate the exact address to the dependent bits.

At 302, network 320 may transmit multi-flow data to NE 330. At 303, NE 330 may map RBs to CBs and/or CBGs. In some example embodiments, NE 330 may add data to MAC PDUs by mapping data from each RB across multiple CBs or CBGs. NE 330 may add data to MAC PDUs such that a one-to-one mapping exists between the RBs and CBs/CBGs, thereby creating a single bundle for each RB.

In an example with RB1 and RB2, data from RB1 may be mapped across CBs 1-N, while data from RB2 may be mapped across CBs (N+1)−M, where Nand Mare integers, and N<M. In this way, NE 330 may use zero padding if data for RB1 and RB2 is insufficient to completely fill CBs N-M. Additionally, the mapping of RBs may be vendor-specific.

Furthermore, NE 330 may attach a CRC to each bundle of CBs/CBGs associated with the same RB. Specifically, NE 330 may perform CB segmentation and/or CB CRC segmentation. In addition, NE 330 may apply any combination of channel coding, rate matching, and scrambling/modulation to the bundle of CBs/CBGs.

At 304, NE 330 may transmit DCI to UE-MAC 340. For example, NE 330 may schedule the UE by transmitting a particular DCI format to UE-MAC 340. The DCI format may indicate to the UE to expect a transmission on physical downlink shared channel (PDSCH), and that different CBs/CBGs within a transmission may be dependent. The DCI format may also indicate a dependency between two consecutive TBs, and make the UE aware of the relationship between the CBs/CBGs, and that recovering a full bundle is sufficient to forward the data to higher layers (i.e., UE-RLC 350).

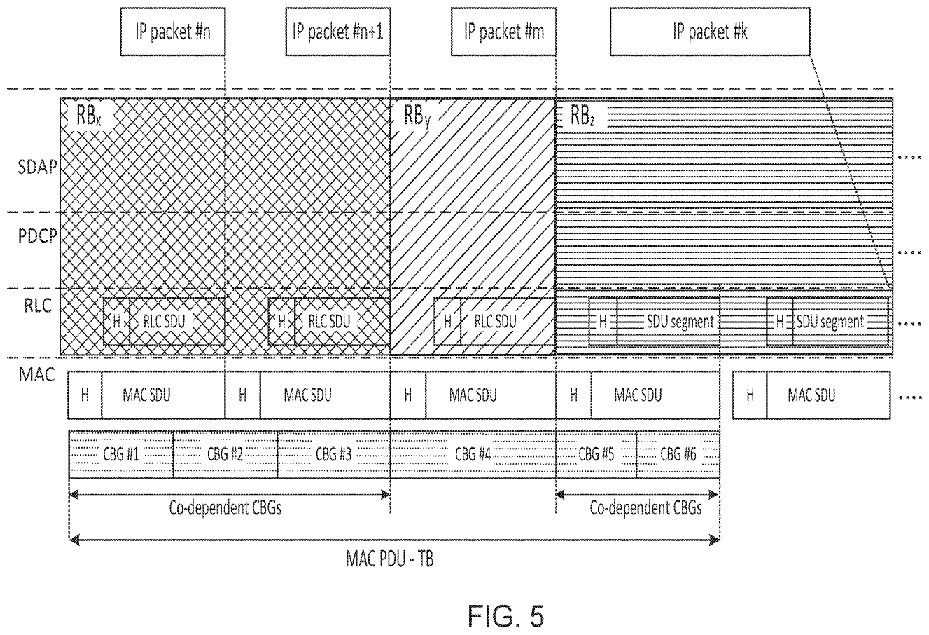

FIG. 5 illustrates MAC PDU partitioning using a mapping from different RBs, where RLC segmentation may be used for IP packets of RB_{z}. In this example, data from three different RBs may be multiplexed into one TB, and the mapping enables independent handling of the CBGs from each of the different RBs. The mapping also introduces dependencies between different CBs/CBGs if the default setting in the network is having independent CBs/CBGs in a single TB. In certain example embodiments, if all CBs/CBGs depend upon each other, the mapping may indicate an interdependency between the separate CBs/CBGs for separate processing of different bundles.

At 305, NE 330 may transmit data to UE-MAC 340, according to the descriptions of the DCI (i.e., scheduled physical resource blocks (PRBs)). At 306, UE-MAC 340 may recover data based upon the DCI instructions received from NE 330 at 304. For example, UE-MAC 340 may decode the DCI and corresponding PDSCH transmissions received from NE 330 based upon different CBs/CBGs depending from the same RB.

Once the data transmission of 305 is complete, the UE may decode the MAC PDU with instructions from the received DCI fields (i.e., CBGDI and CBGNDI). The UE may apply an algorithm to determine which action to take in response to bundle transmission, such as described in Table 1 (description of the steps follow ‘%’ signs):

TABLE 1

| | |
|---|---|
| 1: | Input : DCI information, DL data |
| 2: | Output : UE's MAC layer response to gNB and UE RLC layer |
| 3: | From CBGDI extract NrOfBundles integer; |
| 4: | From CBGNDI extract NewData binary vector; |
| 5: | For i = 1: NrOfBundles |
| 6: | Process the CBGs (CBs) of bundle i |
| 7: | If NewData(i) == 0% reTX data in bundle i |
| 8: | Apply combining with previously received bundle (if combining enabled); |
| 9: | End |
| 10 | If for all the CBs in bundle i, CRC check == true % Data in bundle i is decoded |
| 11 | Forward bundle i to RLC layer; |
| 12 | Send ACK for the CBGs (CBs) in bundle i to gNB; |
| 13: | else % Bundle reception is failed |
| 14: | Send NACK for the failed CBGs (CBs) in bundle i to gNB; |
| 15: | end |
| 16: | end |

At 307, following the determination in 306, UE-MAC 340 may transmit successfully decoded bundles with all CBs correctly decoded to upper layers (e.g., UE-RLC 350). Simultaneously or subsequently, at 308, UE-MAC 340 may transmit, to NE 330, at least one acknowledgement corresponding with a successfully decoded CG/CBG bundle, and/or at least one non-acknowledgement corresponding with an unsuccessfully decoded CG/CBG bundle.

In some example embodiments, UE-MAC 340 may determine, based on CRC per CB, which CBGs were received correctly, and which CBGs resulted in errors. Based upon these determinations, UE-MAC 340 may transmit ACK/NACK messages to NE 330. ACK response(s) may be transmitted to NE 330 for each CBG in the bundle (or one ACK per bundle). If any CBs in the bundle fail, contents of the bundle may be buffered to be combined with subsequent retransmission data, and/or NACK response(s) may be sent to NE 330 for each failed CBG in the bundle (or one NACK per bundle).

At 309, NE 330 may retransmit DCI to UE-MAC 340. At 310, NE 330 may retransmit to UE-MAC 340 any CG/CBG bundles associated with non-acknowledgements received from UE-MAC 340 at 308. At 311, UE-MAC 340 may recover data based upon the DCI instructions received from NE 330 at 309. At 312, UE-MAC 340 may transmit successfully decoded bundles to UE-RLC 350. Upon correctly decoding the previously-failed CB/CBG bundles (e.g., according to bundle CRCs mapped from each RB), UE-MAC 340 may forward CBs/CBGs from the same bundle to UE-RLC 350.

At 313, UE-MAC 340 may transmit, to NE 330, at least one acknowledgement corresponding with a successfully decoded CG/CBG bundle, and/or at least one non-acknowledgement corresponding with an unsuccessfully decoded CG/CBG bundle.

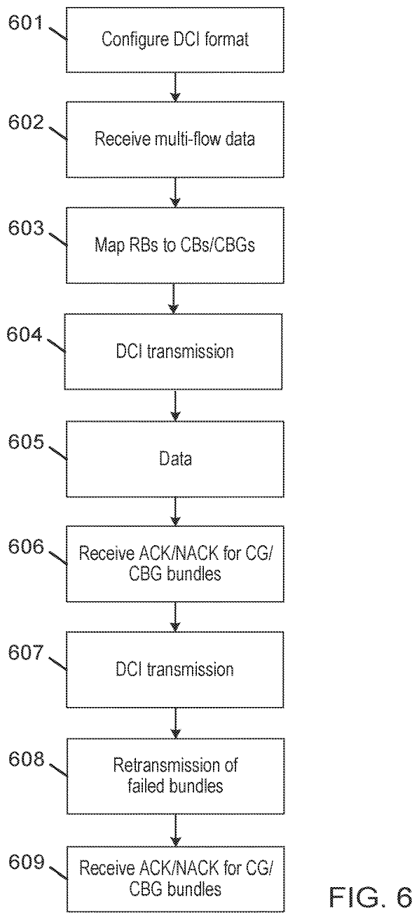

FIG. 6 illustrates an example of a flow diagram of a method that may be performed by a NE, such as NE 810 illustrated in FIG. 8, according to various example embodiments. At 601, the method may include the NE configuring a UE (with UE-MAC and UE-RLC), similar to UE 820 in FIG. 8, to use a particular DCI format. For example, the DCI format may include a CBGDI field, which may define the dependencies between the CBGs (CBG bundles) that define the mapping of different RBs into each CBG bundle. CBGDI may also define dependencies of previous TBs in cases of RLC segmentation. In addition, a CBGNDI field may define if data from each bundle is new (first transmission) or not (retransmission).

In some example embodiments, a CBGDI field may include a vector that indicates starting bits of each of the CB/CBG bundles. For instance, vector [i,j,k] may indicate that the first bundle starts from bit 1 to i−1, the second bundle starts from bit i to j−1, the third bundle starts from bit j to k−1, and the last bundle starts from k until the end of the current TB. Additionally or alternatively, a CBGDI field may include a vector that indicates the length of the bundles, such as [i,j−i,k−j,TBS−k], where TBS shows the TB size. This option may require smaller number of bits compared to the vector above that indicates starting bits.

CBG-based modes may include a CBGDI field with a vector indicating the starting index of the first CBG in the bundle starting from the second bundle (i.e., a bundle always starts from CBG #1). For example, in a scenario with three bundles, the vector could be [x,y] with 1<x<y<C, wherein C is the maximum configured number of CBGs. Therefore, the first bundle may include CBGs 1 to x−1, the second bundle may include x to y−1 and the last bundle may include the remaining CBGs. CBG-based modes may also include a CBGDI field with a vector indicating the length of the bundles by CBG counts, vector [x−1,y−x,C−y+1] with 1<x<y<C. This configuration may require a smaller number of bits compared to the starting index of the first CBG in the bundle.

CBG-based modes may also include a CBGDI field with a vector having C bits, wherein each bit indicates whether the CBG is in a bundle with the previous bundle, similar to DPSK. In this way, the initial phase may be set to 0 if the first CBG is unrelated to the previous TB (e.g., due to RLC segmentation), and may be set to 1 otherwise. As depicted in FIG. 4, 3 RBs may be mapped to 2 TBs, with 8 CBGs in each TB. The CBGDI field may indicate the dependency based on phase shift when the RB index is changing. For TB #2, since the RLC segmentation is present in RB #3 and some of the data was sent in the previous TB, the initial phase starts at 1.

In addition to a CBGDI field, the DCI format may include a CBGNDI field, with options similar to the CBGDI field. For example, a CBGNDI field may indicate the starting bit that contains new data (or retransmission data). Moreover, a CBGNDI field may use only X bits (i.e., number of RBs in current TB), wherein bit 1 indicates new data, and bit 0 indicates retransmission data for each of the RBs. The CBGDI field may indicate the exact address to the dependent bits.

At 602, the method may include the NE receiving multi-flow data. At 603, the method may include the NE mapping RBs to CBs and/or CBGs. In some example embodiments, the NE may add data to MAC PDUs by mapping data from each RB across multiple CBs or CBGs. The NE may add data to MAC PDUs such that a one-to-one mapping exists between the RBs and CBs/CBGs, thereby creating a single bundle for each RB.

In an example with RB1 and RB2, data from RB1 may be mapped across CBs 1-N, while data from RB2 may be mapped across CBs (N+1)−M, where Nand Mare integers, and N<M. In this way, the NE may use zero padding if data for RB1 and RB2 is insufficient to completely fill CBs N-M. Additionally, the mapping of RBs may be vendor-specific.

Furthermore, the NE may attach a CRC to each bundle of CBs/CBGs associated with the same RB. Specifically, the NE may perform CB segmentation and/or CB CRC segmentation. In addition, the NE may apply any combination of channel coding, rate matching, and scrambling/modulation to the bundle of CBs/CBGs.

At 604, the method may include the NE transmitting DCI to the UE-MAC. For example, the NE may schedule the UE by transmitting a particular DCI format to the UE-MAC. The DCI format may indicate to the UE to expect a transmission on PDSCH, and that different CBs/CBGs within a transmission may be dependent. The DCI format may also indicate a dependency between two consecutive TBs, and make the UE aware of the relationship between the CBs/CBGs, and that recovering a full bundle is sufficient to forward the data to higher layers (i.e., UE-RLC).

FIG. 5 illustrates MAC PDU partitioning using a mapping from different RBs, where RLC segmentation may be used for IP packets of RB_{z}. In this example, data from three different RBs may be multiplexed into one TB, and the mapping enables independent handling of the CBGs from each of the different RBs. The mapping also introduces dependencies between different CBs/CBGs if the default setting in the network is having independent CBs/CBGs in a single TB. In certain example embodiments, if all CBs/CBGs depend upon each other, the mapping may indicate an interdependency between the separate CBs/CBGs for separate processing of different bundles.

At 605, the method may include the NE transmitting data to the UE-MAC, according to the descriptions of the DCI (i.e., scheduled PRBs).

At 606, the method may include the NE receiving, from the UE-MAC, at least one acknowledgement corresponding with a successfully decoded CG/CBG bundle, and/or at least one non-acknowledgement corresponding with an unsuccessfully decoded CG/CBG bundle. ACK response(s) may be received for each CBG in the bundle (or one ACK per bundle). If any CBs in the bundle fail, contents of the bundle may be buffered to be combined with subsequent retransmission data, and/or NACK response(s) may be received by the NE for each failed CBG in the bundle (or one NACK per bundle).

At 607, the method may include the NE retransmitting DCI to the UE-MAC. At 608, the NE may retransmit to the UE-MAC any CG/CBG bundles associated with non-acknowledgements received from the UE-MAC. At 609, the method may include the NE receiving from the UE-MAC at least one acknowledgement corresponding with a successfully decoded CG/CBG bundle, and/or at least one non-acknowledgement corresponding with an unsuccessfully decoded CG/CBG bundle.

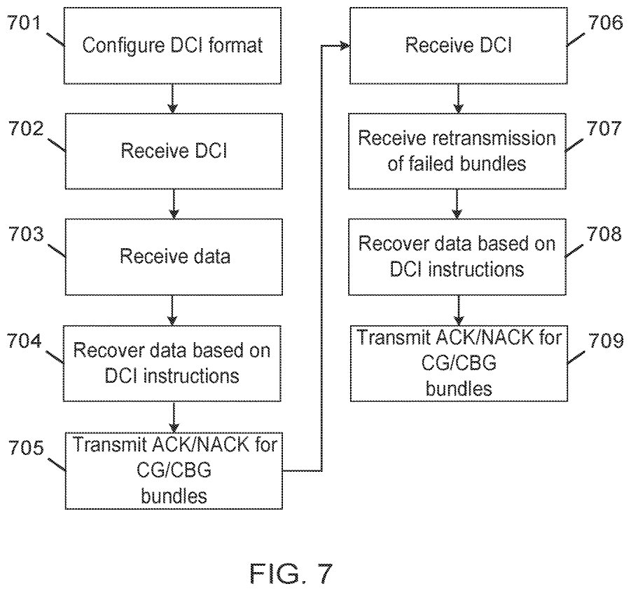

FIG. 7 illustrates an example of a flow diagram of a method that may be performed by a UE, such as UE 820 illustrated in FIG. 8, which may include UE-MAC and UE-RLC, according to various example embodiments. At 701, the method may include the UE configuring to use a particular DCI format. For example, the DCI format may include a CBGDI field, which may define the dependencies between the CBGs (CBG bundles) that define the mapping of different RBs into each CBG bundle. CBGDI may also define dependencies of previous TBs in cases of RLC segmentation. In addition, a CBGNDI field may define if data from each bundle is new (first transmission) or not (retransmission).

In some example embodiments, a CBGDI field may include a vector that indicates starting bits of each of the CB/CBG bundles. For instance, vector [i,j,k] may indicate that the first bundle starts from bit 1 to i−1, the second bundle starts from bit i to j−1, the third bundle starts from bit j to k−1, and the last bundle starts from k until the end of the current TB. Additionally or alternatively, a CBGDI field may include a vector that indicates the length of the bundles, such as [i,j−i,k−j,TBS−k], where TBS shows the TB size. This option may require smaller number of bits compared to the vector above that indicates starting bits.

CBG-based modes may include a CBGDI field with a vector indicating the starting index of the first CBG in the bundle starting from the second bundle (i.e., a bundle always starts from CBG #1). For example, in a scenario with three bundles, the vector could be [x,y] with 1<x<y<C, wherein C is the maximum configured number of CBGs. Therefore, the first bundle may include CBGs 1 to x−1, the second bundle may include x to y−1 and the last bundle may include the remaining CBGs. CBG-based modes may also include a CBGDI field with a vector indicating the length of the bundles by CBG counts, vector [x−1,y−x,C−y+1] with 1<x<y<C. This configuration may require a smaller number of bits compared to the starting index of the first CBG in the bundle.

CBG-based modes may also include a CBGDI field with a vector having C bits, wherein each bit indicates whether the CBG is in a bundle with the previous bundle, similar to DPSK. In this way, the initial phase may be set to 0 if the first CBG is unrelated to the previous TB (e.g., due to RLC segmentation), and may be set to 1 otherwise. As depicted in FIG. 4, 3 RBs may be mapped to 2 TBs, with 8 CBGs in each TB. The CBGDI field may indicate the dependency based on phase shift when the RB index is changing. For TB #2, since the RLC segmentation is present in RB #3 and some of the data was sent in the previous TB, the initial phase starts at 1.

In addition to a CBGDI field, the DCI format may include a CBGNDI field, with options similar to the CBGDI field. For example, a CBGNDI field may indicate the starting bit that contains new data (or retransmission data). Moreover, a CBGNDI field may use only X bits (i.e., number of RBs in current TB), wherein bit 1 indicates new data, and bit 0 indicates retransmission data for each of the RBs. The CBGDI field may indicate the exact address to the dependent bits.

At 702, the UE may receive DCI from a NE. For example, the DCI may schedule the UE by transmitting a particular DCI format to the UE-MAC. The DCI format may indicate to the UE to expect a transmission on PDSCH, and that different CBs/CBGs within a transmission may be dependent. The DCI format may also indicate a dependency between two consecutive TBs, and make the UE aware of the relationship between the CBs/CBGs, and that recovering a full bundle is sufficient to forward the data to higher layers (i.e., UE-RLC 350).

FIG. 5 illustrates MAC PDU partitioning using a mapping from different RBs, where RLC segmentation may be used for IP packets of RB_{z}. In this example, data from three different RBs may be multiplexed into one TB, and the mapping enables independent handling of the CBGs from each of the different RBs. The mapping also introduces dependencies between different CBs/CBGs if the default setting in the network is having independent CBs/CBGs in a single TB. In certain example embodiments, if all CBs/CBGs depend upon each other, the mapping may indicate an interdependency between the separate CBs/CBGs for separate processing of different bundles.

At 703, the UE may receive data, according to the descriptions of the DCI (i.e., scheduled PRBs). In some example embodiments, the data may include MAC PDUs by mapping data from each RB across multiple CBs or CBGs. MAC PDUs may include data such that a one-to-one mapping exists between the RBs and CBs/CBGs, thereby creating a single bundle for each RB.

In an example with RB1 and RB2, data from RB1 may be mapped across CBs 1-N, while data from RB2 may be mapped across CBs (N+1)−M, where Nand Mare integers, and N<M. In this way, zero padding may be used if data for RB1 and RB2 is insufficient to completely fill CBs N-M. Additionally, the mapping of RBs may be vendor-specific.

Furthermore, a CRC may be attached to each bundle of CBs/CBGs associated with the same RB. Specifically, CB segmentation and/or CB CRC segmentation may be performed. In addition, any combination of channel coding, rate matching, and scrambling/modulation to the bundle of CBs/CBGs may also be applied.

At 704, the method may include the UE-MAC recovering data based upon the DCI instructions received from the NE. For example, the UE-MAC may decode the DCI and corresponding PDSCH transmissions received from the NE based upon different CBs/CBGs depending from the same RB. Once the data transmission is complete, the UE may decode the MAC PDU with instructions from the received DCI fields (i.e., CBGDI and CBGNDI). The UE may apply an algorithm to determine which action to take in response to bundle transmission, such as described in Table 1 above.

The UE-MAC may also transmit successfully decoded bundles with all CBs correctly decoded to upper layers (e.g., UE-RLC). Simultaneously or subsequently, at 705, the method may include the UE-MAC transmitting, to the NE, at least one acknowledgement corresponding with a successfully decoded CG/CBG bundle, and/or at least one non-acknowledgement corresponding with an unsuccessfully decoded CG/CBG bundle.

In some example embodiments, the UE-MAC may determine, based on CRC per CB, which CBGs were received correctly, and which CBGs resulted in errors. Based upon these determinations, the UE-MAC may transmit ACK/NACK messages to the NE. ACK response(s) may be transmitted to the NE for each CBG in the bundle (or one ACK per bundle). If any CBs in the bundle fail, contents of the bundle may be buffered to be combined with subsequent retransmission data, and/or NACK response(s) may be sent to the NE for each failed CBG in the bundle (or one NACK per bundle).

At 706, the method may include the UE receiving retransmitted DCI from the UE. At 707, the method may include the UE-MAC 340 receiving any CG/CBG bundles associated with non-acknowledgements. At 708, the UE-MAC may recover data based upon the DCI instructions. The UE-MAC may also transmit successfully decoded bundles to the UE-RLC. Upon correctly decoding the previously-failed CB/CBG bundles (e.g., according to bundle CRCs mapped from each RB), the UE-MAC may forward CBs/CBGs from the same bundle to the UE-RLC.

At 709, the UE-MAC may transmit to the NE at least one acknowledgement corresponding with a successfully decoded CG/CBG bundle, and/or at least one non-acknowledgement corresponding with an unsuccessfully decoded CG/CBG bundle.

FIG. 8 illustrates an example of a system according to certain example embodiments. In one example embodiment, a system may include multiple devices, such as, for example, NE 810 and/or UE 820.

NE 810 may be one or more of a base station, such as an eNB or gNB, a serving gateway, a server, and/or any other access node or combination thereof.

NE 810 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 820 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 810 and/or UE 820 may be one or more of a citizens broadband radio service device (CBSD).

NE 810 and/or UE 820 may include at least one processor, respectively indicated as 811 and 821. Processors 811 and 821 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 812 and 822. The memory may be fixed or removable. The memory may include computer program instructions or computer code contained therein. Memories 812 and 822 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 811 and 821, memories 812 and 822, and any subset thereof, may be configured to provide means corresponding to the various blocks of FIGS. 3-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 8, transceivers 813 and 823 may be provided, and one or more devices may also include at least one antenna, respectively illustrated as 814 and 824. The device may have many antennas, such as an array of antennas configured for multiple input multiple output (MIMO) communications, or multiple antennas for multiple RATs. Other configurations of these devices, for example, may be provided. Transceivers 813 and 823 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 3-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-7. For example, circuitry may be hardware-only circuit implementations, such as analog and/or digital circuitry.

In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

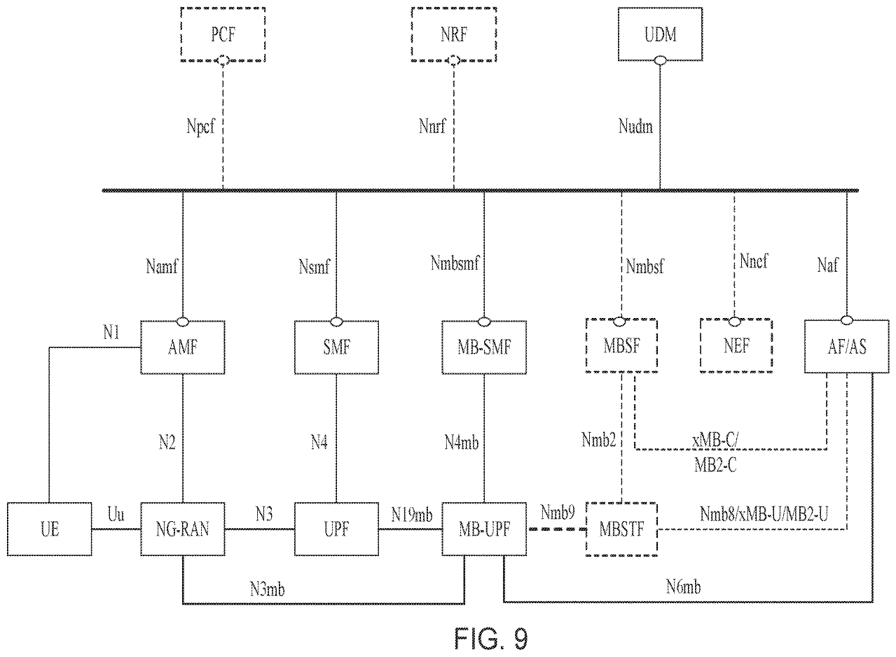

FIG. 9 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 9 may be similar to NE 810 and UE 820, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 811 and 821, and memories 812 and 822, may be included in or may form a part of processing circuitry or control circuitry. In addition, in some example embodiments, transceivers 813 and 823 may be included in or may form a part of transceiving circuitry.

In some example embodiments, an apparatus (e.g., NE 810 and/or UE 820) may include means for performing a method, a process, or any of the variants discussed herein. Examples of the means may include one or more processors, memory, controllers, transmitters, receivers, and/or computer program code for causing the performance of the operations.

In various example embodiments, apparatus 810 may be controlled by memory 812 and processor 811 to transmit downlink control information indicating a dependency between two consecutive transport blocks to a user equipment; transmit a plurality of code blocks of the consecutive transport blocks associated with the same radio bearer comprising a cyclic redundancy check to the user equipment; and receive at least one acknowledgement of successful decoding of at least one of the plurality of code blocks.

In various example embodiments, apparatus 820 may be controlled by memory 822 and processor 821 to receive downlink control information from a network entity indicating a dependency between two consecutive transport blocks; receive a plurality of code blocks of the consecutive transport blocks associated with the same radio bearer comprising a cyclic redundancy check from the network entity; recover data based upon the downlink control information; and transmit at least one successfully decoded bundle with all code blocks correctly decoded to an upper layer of the user equipment; and transmit at least one acknowledgement of successful decoding of at least one the code blocks to the network entity.

Certain example embodiments may be directed to an apparatus that includes means for performing any of the methods described herein including, for example, means for transmitting downlink control information indicating a dependency between two consecutive transport blocks to a user equipment; means for transmitting a plurality of code blocks of the consecutive transport blocks associated with the same radio bearer comprising a cyclic redundancy check to the user equipment; and means for receiving at least one acknowledgement of successful decoding of at least one of the plurality of code blocks.

Certain example embodiments may be directed to an apparatus that includes means for performing any of the methods described herein including, for example, means for receiving downlink control information from a network entity indicating a dependency between two consecutive transport blocks; means for receiving a plurality of code blocks of the consecutive transport blocks associated with the same radio bearer comprising a cyclic redundancy check from the network entity; means for recovering data based upon the downlink control information; means for transmitting at least one successfully decoded bundle with all code blocks correctly decoded to an upper layer of the user equipment; and means for transmitting at least one acknowledgement of successful decoding of at least one the code blocks to the network entity.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
5QI Fifth Generation Quality of Service Indicator
6G Sixth Generation
ACK Acknowledgement
AMF Access and Mobility Management Function
ARQ Automatic Repeat Request
ASIC Application Specific Integrated Circuit
BLER Block Error Rate
BS Base Station
CB Code Block
CBG Code Block Group
CBGDI Code Block Group Dependency Information
CBSD Citizens Broadband Radio Service Device
CG Configured Grant
CPU Central Processing Unit
CRC Cyclic Redundancy Check
CU Centralized Unit
DCCH Dedicated Control Channel
DCI Downlink Control Information
DL Downlink
DPSK Differential Phase Shift Keying
DU Distributed Unit
eMBB Enhanced Mobile Broadband
eNB Evolved Node B
EPS Evolved Packet System
gNB Next Generation Node B
GPS Global Positioning System
HARQ Hybrid Automatic Repeat Request
HDD Hard Disk Drive
IE Information Element
IP Internet Protocol
LTE Long-Term Evolution
LTE-A Long-Term Evolution Advanced
MAC Medium Access Control
MCS Modulation and Coding Scheme
MME Mobility Management Entity
mMTC Massive Machine Type Communication
MTC Machine Type Communication
NACK Negative Acknowledgement
NE Network Entity
NG Next Generation
NG-eNB Next Generation Evolved Node B
NG-RAN Next Generation Radio Access Network
NR New Radio
NR-U New Radio Unlicensed
OFDM Orthogonal Frequency Division Multiplexing
PDA Personal Digital Assistance
PDSCH Physical Downlink Shared Channel
PDU Protocol Data Unit
PRB Physical Resource Block
QoS Quality of Service
RAM Random Access Memory
RAN Radio Access Network
RAT Radio Access Technology
RB Radio Bearer
RE Resource Element
RF Radio Frequency
RLC Radio Link Control
RRC Radio Resource Control
SMF Session Management Function
SRB Signaling Radio Bearer
TB Transport Block
TBS Transport Block Size
TSC Time Sensitive Communication
Tx Transmission
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network
XR Extended Reality

1.-63. (canceled)

64. An apparatus, comprising:
at least one processor; and
at least one memory including computer program code,
wherein the at least one memory and the computer program code are configured to, with the at least one processor, cause the apparatus at least to:
transmit downlink control information indicating a dependency between two consecutive transport blocks to a user equipment;
transmit a plurality of code blocks of the consecutive transport blocks associated with the same radio bearer comprising a cyclic redundancy check to the user equipment; and
receive at least one acknowledgement of successful decoding of at least one of the plurality of code blocks.

65. The apparatus of claim 64, wherein the at least one memory and the computer program code are further configured to, with the at least one processor, cause the apparatus at least to:
configure the user equipment to use a particular downlink control information format.

66. The apparatus of claim 64, wherein the at least one memory and the computer program code are further configured to, with the at least one processor, cause the apparatus at least to:
receive multi-flow data from a network.

67. The apparatus of claim 64, wherein the at least one memory and the computer program code are further configured to, with the at least one processor, cause the apparatus at least to:
add data to at least one medium access control protocol data unit by mapping data from each radio bearer across multiple code blocks or code block groups.

68. The apparatus of claim 64, wherein the adding comprises adding data to medium access control protocol data units such that a one-to-one mapping exists between the radio bearers and code blocks.

69. The apparatus of claim 64, wherein the at least one memory and the computer program code are further configured to, with the at least one processor, cause the apparatus at least to:
transmit data according to descriptions of the downlink control information to the user equipment.

70. The apparatus of claim 64, wherein the downlink control information comprises a code block new data indicator field indicating whether data from the a plurality of code blocks is new or not new.

71. An apparatus, comprising:
at least one processor; and
at least one memory including computer program code,
wherein the at least one memory and the computer program code are configured to, with the at least one processor, cause the apparatus at least to:
receive downlink control information from a network entity indicating a dependency between two consecutive transport blocks;
receive a plurality of code blocks of the consecutive transport blocks associated with the same radio bearer comprising a cyclic redundancy check from the network entity;
recover data based upon the downlink control information;
transmit at least one successfully decoded bundle with all code blocks correctly decoded to an upper layer of the user equipment; and
transmit at least one acknowledgement of successful decoding of at least one the plurality of code blocks to the network entity.

72. The apparatus of claim 71, wherein the at least one memory and the computer program code are further configured to, with the at least one processor, cause the apparatus at least to:
configure the user equipment to use a particular downlink control information format.

73. The apparatus of claim 71, wherein the at least one memory and the computer program code are further configured to, with the at least one processor, cause the apparatus at least to:
receive data from the network entity according to descriptions of the downlink control information.

74. The apparatus of claim 71, wherein the downlink control information indicates a one-to-one mapping between the radio bearers and code blocks.

75. The apparatus of claim 71, wherein the downlink control information comprises a code block dependency information field defining dependencies between the code blocks within a transport block.

76. The apparatus of claim 71, wherein the downlink control information comprises a code block dependency information field defining dependencies of previous transport blocks associated with radio link control segmentation.

77. The apparatus of claim 71, wherein the downlink control information comprises a code block new data indicator field indicating whether data from the a plurality of code blocks is new or not new.

78. The apparatus of claim 71, wherein the data is recovered by decoding the downlink control information and corresponding physical downlink shared channel transmissions received from the network entity based upon different code blocks depending from the same radio bearer.

79. The apparatus of claim 71, wherein the at least one memory and the computer program code are further configured to, with the at least one processor, cause the apparatus at least to:
transmit at least one non-acknowledgement corresponding with an unsuccessfully decoded code block bundle.

80. An apparatus, comprising:
means for receiving downlink control information from a network entity indicating a dependency between two consecutive transport blocks;
means for receiving a plurality of code blocks of the consecutive transport blocks associated with the same radio bearer comprising a cyclic redundancy check from the network entity;
means for recovering data based upon the downlink control information;
means for transmitting at least one successfully decoded bundle with all code blocks correctly decoded to an upper layer of the user equipment; and
means for transmitting at least one acknowledgement of successful decoding of at least one the plurality of code blocks to the network entity.

81. The apparatus of claim 80, further comprising:
means for configuring the user equipment to use a particular downlink control information format.

82. The apparatus of claim 80, further comprising:
means for receiving data from the network entity according to descriptions of the downlink control information.

83. The apparatus of claim 80, wherein the downlink control information comprises a code block new data indicator field indicating whether data from the plurality of code blocks is new or not new.
